(19) United States
(12) Patent Application Publication
(10) Pub. No.: US 2005/0279392 A1
(43) Pub. Date: Dec. 22, 2005

(54) Adjustable walker

(76) Inventor: Gerald Lapierre, L' Etang-du-Nord (CA)

Correspondence Address: Gerald Lapierre, 13 allee Leo Leblanc, L' Etang du Nord, QC, G4T 3X9, CA

(21) Appl. No.: 11/121,710

(22) Filed: May 5, 2005

(30) Foreign Application Priority Data
May 18, 2004 (CA) CA2466963

(51) Int. Cl. A61H 3/02

(52) U.S. Cl. 135/68

(57) ABSTRACT

An “adjustable walker” is disclosed comprising an adjustable U shape supporting device for the knee or the leg of a person having a sore or injured foreleg, foot or ankle, installed in a manner it replaces traditional crutches to move around or to complete daily chores, and can be used as a leg stool when someone sits because the walker stands on four adjustable legs; this invention can greatly accelerate the healing and rehabilitation of the patient, add movement comfort, reduces physiotherapy after a cast removal if invention is used during immobilization period, and could reduce health care costs.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND

The invention relates to the fields of walking aids given to help the rehabilitation of foot injured people that can still use their-knee.

The most common method, in the medical field, to heal an injured foot, ankle or foreleg is immobilization with a cast or bandage and avoid ground contact with the injured leg. The patient usually receives crutches (either forearm or underarm ones) to give him or her the possibility of independent mobility.

Problems exists with the use of crutches. First, the underarm model can hurt the shoulders and both hands are busy while moving around. Secondly, the injured leg is hanging, making the blood pressure higher in the foot than if it was a bit closer to the heart. Crutches also put unbalanced stress on the hips. Even a careful person will now and then put his or her foot on the ground while using crutches.

Crutches are also a problem when standing still and the person wants to use arms and hands to do something. The crutches are in the way, they limit movement of the arms. Furthermore, the body of the person is not in an ergonomic posture.

Conventional walkers, like U.S. Pat. No. 5,882,067 are useful for people with a temporary or permanent light loss of balance or strength in the legs but can still make use of both arms and both legs. Walkers comprise a tubular structure made to surround the person further comprising two legs on the left side and two legs on the right side and handles on each side. Some walkers also comprise a seat so the person can rest between movements.

The present invention is made to be used by people that temporarily loose the use of the ankle or foot, because of an injury, that needs immobilization, healing and/or rehabilitation and find unbearable the use of crutches.

The inventor used his adjustable walker the day after a foot injury (fracture) and the foot healed a lot faster (50%) than if he would have used crutches. Surgeons have confirmed it verbally and by writing. The reasons are simple: with the foot higher in the air, blood pressure is lowered, reducing the swelling faster and accelerating the healing. Furthermore, the hips are always level while standing and the hands are free to be used, and the injured foot never touches ground. While sitting, the injured leg can be held in the air by a supporting device on the invention, and can be used as a foot stool, further reducing blood pressure and accelerating healing.

The invention received a Canadian patent issued in February 2005 and known as patent number CA 2,466,963 and named “adjustable walker”.

### BRIEF SUMMARY OF THE INVENTION

The “adjustable walker” can quicken the healing of an injured foot, ankle or foreleg of a patient that would normally use crutches after medical treatment, and where the knee of that injured leg can be used as support.

The invention only need one arm to be used by someone, the arm on the same side of the injured or hurt leg. The knee rests on a supporting device so the foot cannot touch the ground and is elevated, helping blood circulation and general healing.

The “adjustable walker” makes moving around more comfortable for the user than for a crutch user.

The invention helps the injured person stand up, walk and get certain activities done without any other assistance.

The equipment moves along with the knee, with the help of an ergonomic and adjustable handle, same principle as a cane.

The mechanism is equipped with four telescopic legs, which allows the walker to adjust height of the supporting device and then stand on its own without having to hold the invention. When a person stands up still, the “adjustable walker” is used as a support for the knee and, therefore, it allows for a better balance.

Moreover, to go up and down the stairs, it becomes more secure and more efficient than crutches.

While the person sits down, the invention can also be used as a stool to support the injured leg at a desirable and comfortable height.

The “adjustable walker” can also be very useful when the injured person is taking a shower cause both hands are free to clean, rub, rinse and dry body parts.

When in movement or when walking, there is always one hand free to do something useful with.

The equipment has adjustable mechanisms, which allows it to be used either from the right or the left side and by people of various heights.

### BRIEF DESCRIPTION OF THE SEVERAL VIEWS OF THE DRAWINGS

FIG. 1 is a front view of one embodiment of the adjustable walker of the present invention, shown here for a left side use.

FIG. 2 is a outside view of the adjustable walker as shown in FIG. 1

FIG. 3 is a rear view of the adjustable walker as shown in FIG. 1

FIG. 4 is a inside view of the adjustable walker as shown in FIG. 1

### DETAILED DESCRIPTION OF THE INVENTION

The present invention is an adjustable walker configured to assist a foreleg, foot or ankle injured person in walking as in standing, so it reduces fatigue and improves healing. The presented walker can replace the usually offered crutches and has number of technical advantages for the user and the manufacturer.

The walker is sized generally to accommodate use by persons of various heights and sizes and is built big enough to hold the knee and part of the leg of the user comfortably, and small enough to be easily displaced or stored.

The walker shown in the drawings comprises a U shape supporting device 6 (also called a seat in Canadian patent CA 2,466,963) for the knee or the foreleg of a injured person, further comprising four adjustable telescopic legs 9a and 9b and 9c and 9d, four leg piping 8a and 8b and 8c and 8d fixed to the supporting device 6, an adjustable handle 1, so the invention can be used either for a left side use or a right side use.

The walker may be built from any suitable material or materials capable of supporting loads and stresses applied during use. In one embodiment, the frame components comprise aluminium piping.

The frame components comprise four leg piping 8a and 8b and 8c and 8d, leg braces 10a and 10b and 10c and 10d, handle braces 5a and 5b, fixed handle piping 4 and the supporting device 6. The frame components are rigidly connected to each other so that relative movement is impossible.

The leg piping 8a and 8b and 8c and 8d comprise smaller inside diameter compared to the telescopic legs 9a and 9b and 9c and 9d outside diameter to allow translatory movement of each telescopic leg 9a and 9b and 9c and 9d inside the corresponding leg piping 8a and 8b and 8c and 8d, further comprise aligned adjustment slots on one side so telescopic legs 9a and 9b and 9c and 9d can be locked at a preferred height, with help of the push button installed on each telescopic leg 9a and 9b and 9c and 9d, and prevent further translatory movement. These slots are installed in a manner to avoid structural failure and provide enough height adjustment possibilities.

The adjustment slots of the leg piping 8b and 8c are not level with leg piping 8a and 8d in respect to the plane created with the underneath of supporting device 6, this allows better stability in use when front legs are adjusted a bit longer than the back legs.

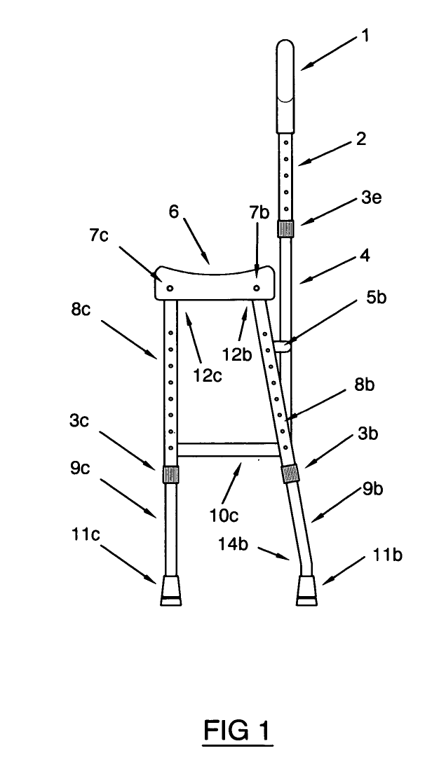

The U shape supporting device 6 is generally made of a lightweight and comfortable material such as carbon fibre, fibreglass or plastic. In the preferred embodiment, it is made of plastic. The supporting device 6 is fixed to the four leg piping 8a and 8b and 8c and 8d with rivets 7a and 7b and 7c and 7d, so relative movement is impossible. The shape of the supporting device 6 resembles a U when looking at the walker from the front, as in FIG. 1, and can hold many knee or leg sizes so they can rest in comfort, and be adaptable to as many people as possible.

Between each leg piping 8a and 8b and 8c and 8d and corresponding telescopic legs 9a and 9b and 9c and 9d is installed a stabilizing flange 3a and 3b and 3c and 3d. These are generally made of a lightweight material such as fibreglass, aluminium or plastic. In an embodiment, the stabilizing flanges 3a and 3b and 3c and 3d are made of aluminium and can be twisted on threads grooved on each leg piping 8a and 8b and 8c and 8d, so they tighten both parts together and better hold the structure.

The frame components comprise braces 10a and 10b and 10c and 10d between leg piping 8a and 8b and 8c and 8d to avoid relative movement between components. Braces 10a and 10b and 10c and 10d are made of the same material as leg piping 8a and 8b and 8c and 8d but can differ in diameter and/or thickness. The arrangement of braces are generally level with the plane created with the underneath of the supporting device 6, but other embodiments can receive skewed braces 10a and 10b and 10c and 10d between leg piping 8a and 8b and 8c and 8d.

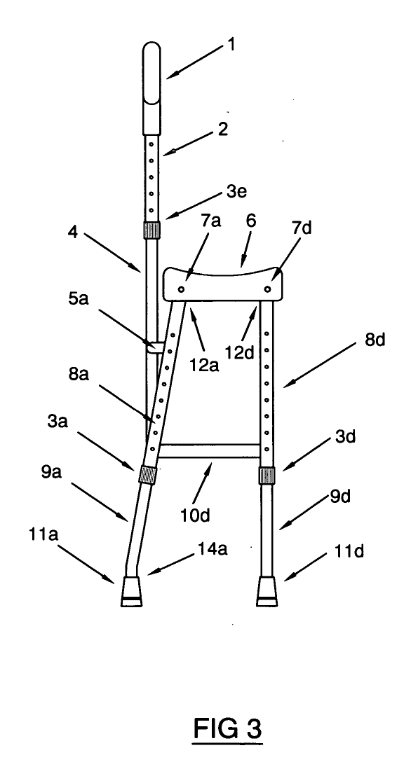

Outside leg piping 8a and 8b have a 102 degree angle 12a and 12b in respect with plane created with underneath of supporting device 6 as in FIGS. 1 and 3. This angle presents structural advantages to improve stability and allow attachment of handle piping 4 on handle braces 5a and 5b and on leg brace 10a. The joints between these elements are held with solder.

Lower part of telescopic legs 9a and 9b comprise a 168 degree angle 14a and 14b allowing each corresponding rubber tip 11a and 11b to be level with the ground. Rubber tips 11a and 11b and 11c and 11d are generally made of non-skid material such as rubber and fit tightly on one end of each telescopic leg 9a and 9b and 9c and 9d.

Inside leg piping 8c and 8d have a 95 degree angle 12c and 12d with plane created with underneath of supporting device 6 as in FIGS. 1 and 3.

Handle piping 4 in the preferred embodiment comprises a smaller diameter than the diameter of telescopic handle piping 2 so it can allow translatory movement of the latter. In other embodiments, the handle piping 4 is of a bigger diameter than the one of the telescopic handle piping 2. In one embodiment, the handle piping 4 has two push buttons to accommodate aligned adjustment slots of the telescopic handle piping 2 and to permit many height adjustment possibilities for the handle 1 and a 180 degree pivot of handle 1 so the invention can be used either from the left side or the right side. In other embodiments, slots are on the handle piping 4 and the push buttons are on the telescopic handle piping 2. Between handle piping 4 and telescopic handle piping 2 is installed a stabilizing flange 3e that can be twisted on threads grooved on handle piping 4, so it tightens the two parts together and avoid relative movement.

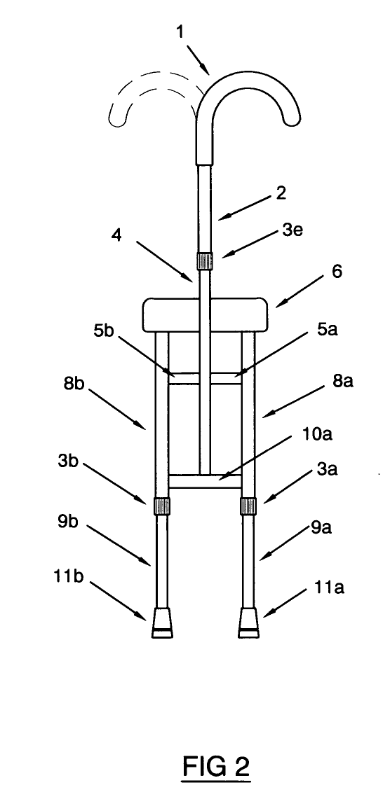

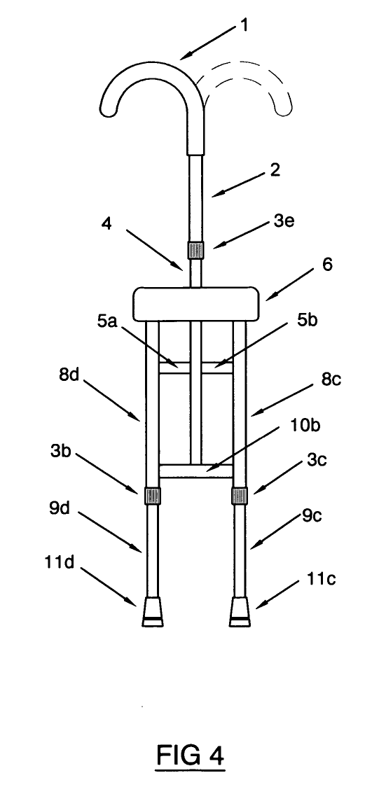

Telescopic handle piping 2 is generally made of a straight bottom part and a curved top part, the top part receiving a non-skid tubing to make handle 1. This configuration is presented in FIGS. 1 to 4. In other embodiments, the telescopic handle piping 2 receives a configuration to be more ergonomic to the user. It can, for example, comprise more curves or a more comfortable top part, so the handle is also more comfortable.

The handle tubing 1 is made of a non-skid, soft and durable material such as rubber. Other material or combination of materials can also be used to improve handling and comfort of the adjustable walker.

1. A walker that can replace two crutches, comprising a U shape supporting device for the knee or the foreleg of a person, and four legs where upper part leg piping is fixed to said supporting device and lower part is a telescopic leg, further comprising an adjustable handle assembly, where lower part handle piping is fixed on one side of the walker by two braces, and the top part is a telescopic handle piping, being adjustable vertically and in torsion;

2. the walker of claim 1, wherein said legs and said handle assembly each comprise a stabilizing flange;

3. the walker of claim 1, wherein said legs and said handle assembly each comprise adjustment slots in one part and push buttons on the other in order to have telescopic legs and telescopic handle;

4. the walker of claim 1, wherein lower end of each said telescopic leg comprises a non-skid tip;

5. the walker of claim 1, wherein said U shape supporting device is secured to each said leg piping by rivets;

6. the walker of claim 1 further comprising braces to secure said leg piping;

7. the walker of claim 1 further comprising braces to secure the handle piping to two of the leg piping called outer legs, wherein joints are held by solder;

8. the walker of claim 1, wherein each inner side leg has a 95 degree angle with underneath of said U shape supporting device;

9. the walker of claim 1, wherein each outer leg has a 102 degree angle with underneath of said U shape supporting device;

10. the walker of claim 9, wherein lower end of each said outer leg has a 168 degree angle with its upper part;

11. the walker of claim 7, wherein said braces joining said leg piping together are held by solder;

12. the walker of claim 1, wherein adjustment slots of the two front legs are different in height from the two back legs to insure stability while the person is using said walker;
